(19) United States
(12) Patent Application Publication
(10) Pub. No.: US 2011/0258434 A1
(43) Pub. Date: Oct. 20, 2011

(54) ONLINE SECURE DEVICE PROVISIONING WITH UPDATED OFFLINE IDENTITY DATA GENERATION AND OFFLINE DEVICE BINDING

(75) Inventors: Xin Qiu, San Diego, CA (US); Alexander Medvinsky, San Diego, CA (US); Stuart P. Moskovics, San Diego, CA (US); Greg N. Nakanishi, San Diego, CA (US); Jason A. Pasion, San Diego, CA (US); Fan Wang, San Diego, CA (US); Ting Yao, San Diego, CA (US)

(73) Assignee: GENERAL INSTRUMENT CORPORATION, Horsham, PA (US)

(21) Appl. No.: 13/087,972

(22) Filed: Apr. 15, 2011

Related U.S. Application Data
(60) Provisional application No. 61/324,569, filed on Apr. 15, 2010.

(51) Int. Cl. H04L 9/00

(52) U.S. Cl. 713/153

(57) ABSTRACT

A system for generating new identity data for network-enabled devices includes a whitelist reader configured to extract attributes from a whitelist. The whitelist includes, for each device specified in the whitelist, a previously assigned identifier of the first type. The previously assigned identifiers of the first type are linked to identity data previously provisioned in each of the respective devices. A data retrieval module is configured to receive the identifiers of the first type from the whitelist reader and, based on each of the identifiers, retrieve each of the previously provisioned identity data records linked thereto. A new data generation module is configured to (i) obtain a cryptographic key associated with the identity data previously provisioned in the devices specified on the whitelist and the corresponding identifiers of the first type, (ii) generate new identity data records each linked to a new identifier and (iii) encrypt each of the new identity data records with one of the cryptographic keys and link each new identity data record to the identifier of the first type corresponding to each respective cryptographic key. A data output module is configured to load onto an external source the encrypted new identity data records along with their respective new identifiers and their respective previously assigned identifiers of the first type.

### RELATED APPLICATIONS

This application claims priority from U.S. provisional application No. 61/324,569, filed Apr. 15, 2010, which is incorporated by reference herein in its entirety.

This application is related to co-pending U.S. application Ser. No. 12/961,455 filed on Dec. 6, 2010, entitled “Online Public Key Infrastructure (PKI) System.” This application is also related to co-pending U.S. application Ser. No. ______ [BCS06335], filed Apr. 15, 2011, entitled “Online Secure Device Provisioning Framework.”

### BACKGROUND

Digital information has become extremely important in all aspects of commerce, education, government, entertainment and management. In many of these applications, the ability to ensure the privacy, integrity and authenticity of the information is critical. As a result, several digital security mechanisms have been developed to improve security.

One standardized approach to today's digital security is referred to as the Public Key Infrastructure (PKI). PKI provides for use of digital certificates to authenticate the identity of a certificate holder, or to authenticate other information. A certificate authority (CA) issues a certificate to a certificate holder and the holder can then provide the certificate to a third party as an attestation by the CA that the holder who is named in the certificate is in fact the person, entity, machine, email address user, etc., that is set forth in the certificate. And that a public key in the certificate is, in fact, the holder's public key. People, devices, processes or other entities dealing with the certificate holder can rely upon the certificate in accordance with the CA's certification practice statement.

A certificate is typically created by the CA digitally signing, with its own private key, identifying information submitted to the CA along with the public key of the holder who seeks the certificate. A certificate usually has a limited period of validity, and can be revoked earlier in the event of compromise of the corresponding private key of the certificate holder, or other revocable event. Typically, a PKI certificate includes a collection of information to which a digital signature is attached. A CA that a community of certificate users trusts attaches its digital signature and issues the certificates to various users and/or devices within a system.

Network-enabled devices are generally provisioned at the factory with identity data so that they may communicate with other network-enabled devices in a secure manner using an identity data system. The identity data typically includes a public and private key pair and a digital certificate. Illustrative examples of networked-enabled devices include, without limitation, PCs, mobile phones, routers, media players, set-top boxes and the like.

The identity data may be provisioned in network-enabled devices before or after they are deployed in the field. For instance, the identity data may be incorporated into the device at the time of manufacture. For example, a large scale upgrade may occur when a network operator wants to replace their Digital Rights Management (DRM) system or when they want to support other security applications that require the network-enabled devices to be provisioned with new types of identity after the devices have been deployed. This can be a difficult and cumbersome process because it is often performed manually and therefore can require the devices to be returned to a service center.

One particular issue that arises when upgrading or updating identity data concerns the manner in which new identity data is generated and bound to the network-enabled devices.

### SUMMARY OF THE INVENTION

In accordance with the present invention, a system for generating new identity data for network-enabled devices is provided. The system includes a whitelist reader configured to extract attributes from a whitelist that includes, for each device specified in the whitelist, a previously assigned identifier of the first type. The previously assigned identifiers of the first type are linked to identity data previously provisioned in each of the respective devices. A data retrieval module is configured to receive the identifiers of the first type from the whitelist reader and, based on each of the identifiers, retrieve each of the previously provisioned identity data records linked thereto. A new data generation module is configured to (i) obtain a cryptographic key associated with the identity data previously provisioned in the devices specified on the whitelist and the corresponding identifiers of the first type, (ii) generate new identity data records each linked to a new identifier and (iii) encrypt each of the new identity data records with one of the cryptographic keys and link each new identity data record to the identifier of the first type corresponding to each respective cryptographic key. A data output module is configured to load onto an external source the encrypted new identity data records along with their respective new identifiers and their respective previously assigned identifiers of the first type.

In accordance with another aspect of the invention, a method for generating new identity data for network-enabled devices is provided. The method includes receiving a whitelist that specifies a plurality of network-enabled devices to be provisioned with new identity data. For each device, the whitelist includes a previously assigned identifier of the first type, wherein the previously assigned identifiers of the first type are linked to identity data records previously provisioned in each of the respective devices. The identifiers of the first type are extracted from the whitelist and, based on each of the identifiers, each of the previously provisioned identity data records linked thereto are retrieved. A cryptographic key is obtained, which is associated with the identity data records previously provisioned in the devices specified on the whitelist and the corresponding identifiers of the first type. New identity data records are generated which are each linked to a new identifier. Each of the new identity records is encrypted with one of the cryptographic keys and linked to the previously assigned identifier of the first type corresponding to each respective cryptographic key. An output is provided which includes, for each of the devices specified on the whitelist, the encrypted new identity records along with their respective new identifiers and their respective previously assigned identifiers of the first type.

### BRIEF DESCRIPTION OF THE DRAWINGS

FIGS. 1A and 1B show one example of an operating environment in which the processes described herein for provisioning network-enabled devices with identity data may be implemented.

FIG. 2 shows one example of a generic whitelist that may be used for both online request message authentication and offline new identity generation/binding to a specific network-enabled device.

FIGS. 3a and 3b show examples of whitelists that may be employed when authorization and device binding are performed during the new PKI identity generation process.

FIGS. 4A and 4B show an example of the PKI/identity generation system when it is used to perform both PKI data generation and device binding.

FIGS. 5A and 5B show one example of an update server which receives the output from the PKI/identity generation system of FIGS. 4A and 4B and PKI data requests from the network-enabled devices.

### DETAILED DESCRIPTION

An identity data management system is described herein which provides a flexible framework that can be used to upgrade, renew, or supplement identity data that is provisioned in a large base of network-enabled devices that have already been deployed in the field. The system architecture allows network operators to install and update the identity data in these devices without having to recall them from the end-user. The system architecture may also allow operators to update expired or expiring digital certificates provisioned in previously deployed network-enabled devices with minimum service disruption. In a common scenario, for instance, a service provider may have acquired, say, 500,000 units of a product that they have delivered to their end user customers. For one reason or another, the service provider may wish to update the identity data in all or a subset (e.g., 100,000) of those units. In one particular instance the identity data is PKI data. In other cases the identity data may take a variety of other forms such as a serial number, a symmetric key that is cryptographic based, and the like. For purposes of illustration only and not as a limitation on the invention the following description will often refer to a PKI management system that is used to upgrade, renew, or supplement PKI data.

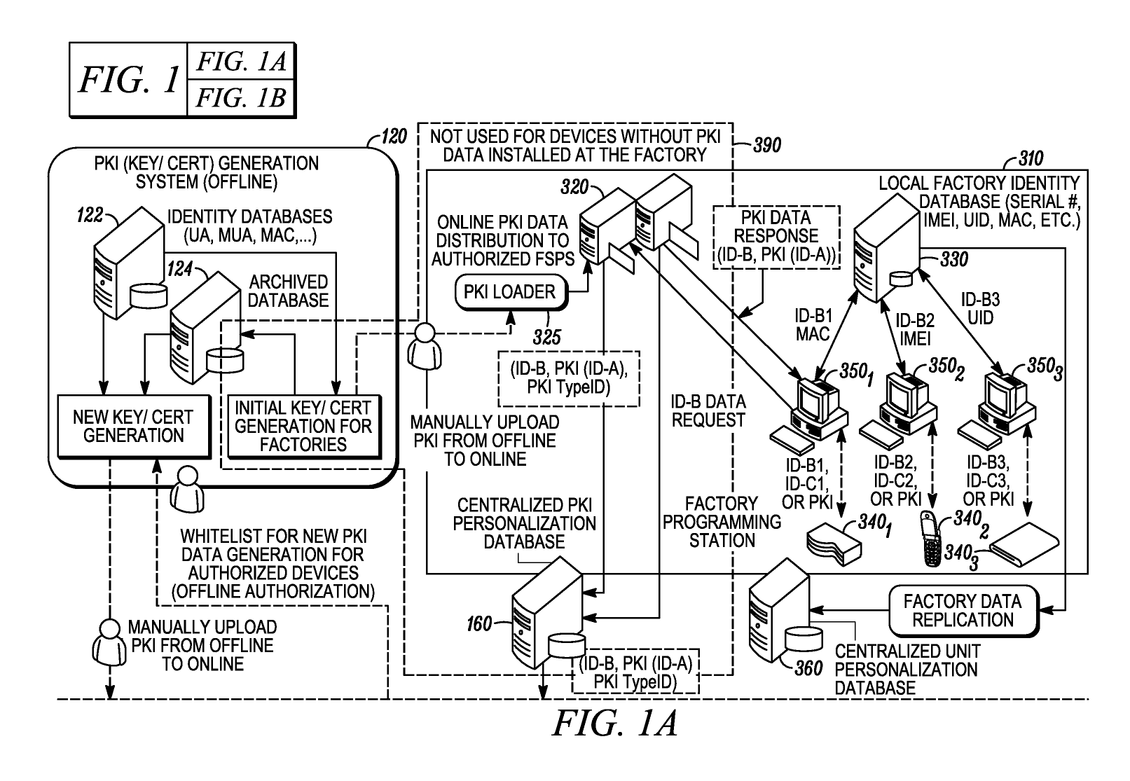

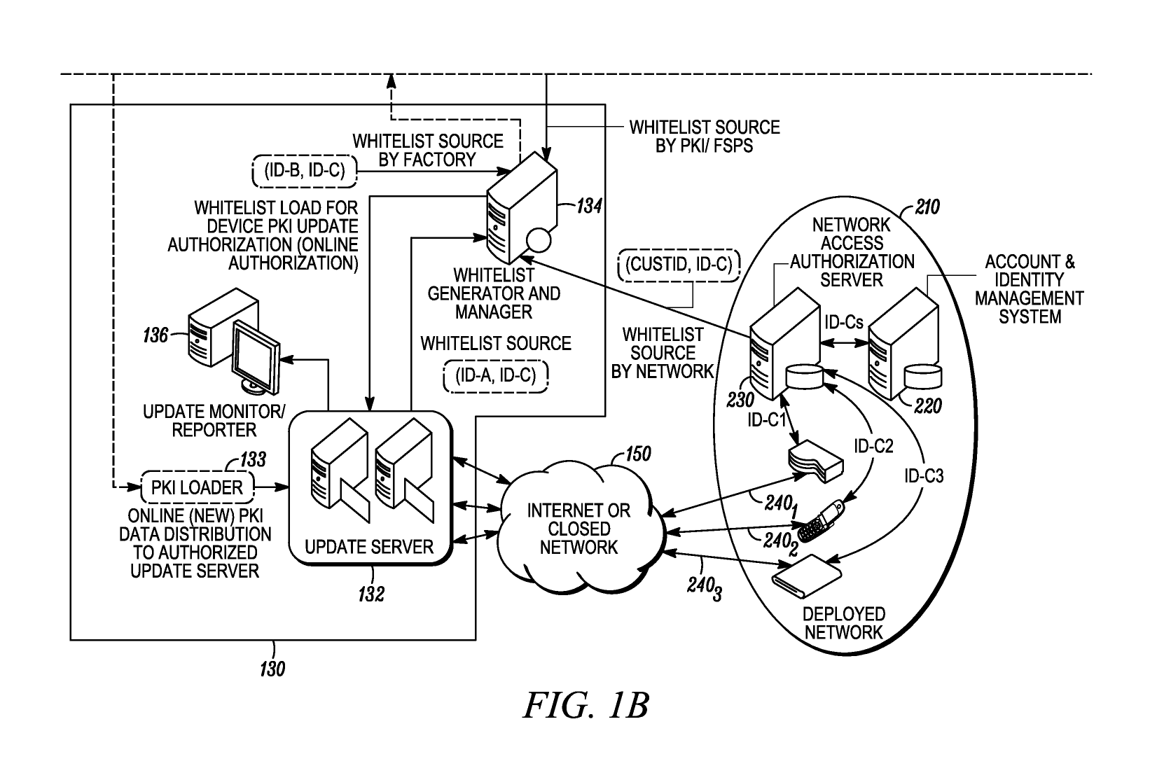

FIGS. 1A and 1B show one example of an operating environment in which the processes described herein for provisioning network-enabled devices with identity data may be implemented. This example shows a number of different domains representative of the different parties that may be involved in the data identity provisioning/update process. In this example three domains are shown: a factory domain 310 representing a manufacturing site for network-enabled devices; a deployed network domain 210 controlled by a network operator that operates the network in which the network-enabled devices are used; and a PKI/identity management system domain 120 operated by a PKI center operator. Although in general these domains may be maintained operated by the different entities, in some cases they may be operated by the same entities. For instance, the factory domain 310 and the PKI/identity management system domain 120 are sometimes under the control of the same entity.

It should be understood that each domain in FIGS. 1A and 1B is shown in a highly simplified manner in which a single entity (e.g., server, database, etc) may be representative of more complex arrangements and systems. For instance, as explained below, the factory domain includes a factory database 330 which is used to track components used in the manufacturing process, purchase and shipping orders, and so on. In reality, there may be many different systems and entities involved in this process, all of which are represented herein by factory database 330.

The manufacturing domain 310 of a single manufacturer may include multiple manufacturing sites which in some cases can be operated by a third party contract manufacturer distributed world-wide. Each factory, only one of which is illustrated in FIGS. 1A and 1B, may produce a single type or single class of network-enabled devices (e.g., mobile phones) or multiple classes of devices (e.g., mobile phones, routers and set-top boxes). FIGS. 1A and 1B show one illustrative manufacturing site, factory 310, which includes the aforementioned local factory database 330, factory programming stations 350 that allow factory personnel to access the factory database and the network-enabled devices 340₁, 340₂, and 340₃ (“340”) being produced, and factory servers 320 that are used to communicate with the PKI system 120 and store the PKI identity data received therefrom.

The network 210 includes a network access authorization server 230, which grants permission to the deployed network-enabled devices 240₁, 240₂, and 240₃ (“240”) to access the network and initiate upgrade operations. Identity data and other information concerning the deployed devices 240 are maintained by an account identity and management system 220.

In addition to the identity management components located at the factory site 310 discussed above, the PKI/identity management system includes two primary sub-systems: a PKI/identity generation system 120 and a PKI/identity update system 130. The PKI/identity generation system 120, which for security reasons is often an offline system, includes order fulfillment processors 122, which generate digital certificates or other identity data requested for products. The order fulfillment processors 122 may include, or have access to, hardware security modules (HSMs) in which the CA's certificate signing private keys and secure data may be stored for use by the system. The PKI/identity generation system 120 also includes an archive database 124, which is a database of records. These records may pertain to issued digital certificates, original requests for new digital certificates or secure data, audit data, organization information, product configurations, user information, and other record types as necessary.

The PKI/identity update system 130 includes a PKI/identity update server 132 that receives new identity data from the offline PKI/identity generation system 120 and securely downloads the new identity data to the appropriate deployed network-enabled devices 240. The PKI/identity update system 130 also includes a whitelist generation and manager (WGM) server 134 for consolidating various identifies received from different whitelist sources maintained within the various domains, i.e., the PKI/identity generation domain, the device manufacturer domain and the service provider/network operator domain. In particular, WGM server 134 receives one set of device identifiers from the factory via a unit personalization database 160, which has all the data retrieved from different manufacturing sites and another set of device identifiers, one of which is assigned by the PKI/identity generation system 120, from PKI personalization database 160. Other sources of whitelist data, either from network operators or update servers 132, will be discussed below. These identifiers and other data allow the WGM server 134 to correlate the various identifiers that are assigned to same network-enabled device.

A high-level overview of the secure device provisioning process flow as shown in FIGS. 1A and 1B will be presented. At the outset, it should be noted that different domains may assign its own identifier which are to be associated with the network enabled devices, and these identities need to be tracked and correlated with one another in order to perform a PKI/identity update. In particular, the PKI center coordinator assigns an identifier, referred to herein as ID-A, to each PKI/identity data unit that will ultimately be provisioned in a network-enabled device at the factory. If an identity data unit includes a public-private key pair and a digital certificate, its ID-A will be included in the certificate. Likewise, the manufacturer assigns an identifier, denoted ID-B to each device 340 it manufactures. This identifier will often be in the form of a hardware-based identifier such as a MAC Address, an International Mobile Equipment Identity Number (IMEI) or a unit ID (UID), for example. In addition, the manufacturer may also assign another identifier, denoted ID-C, which may be in the form of a label such as a serial number or the like Unlike the other identifiers, the label will often be visible on the device itself In part for this reason, the network operator will generally use the identifier ID-C within its own domain. In some cases the identifiers ID-B and ID-C may be the same.

When a network-enabled device is first provisioned with identity data, the PKI/identity generation system 120 generates the initial identity data for each device and delivers it to the factory servers 320. Each identity data unit that is provided to the factory servers 320 includes its identifier ID-A. When the manufacturer is ready to first load a newly manufactured device with identity data, the factory stations 350 will request an identity data record by providing the factory servers 320 with the device's identifier ID-B. In response, the factory servers 320 will provide the factory stations 350 with an identity data record identified by its identifier ID-A. Both of these identifiers will be stored in the factory servers 320 and replicated to a identity database 160, which associates both identifiers with one another to indicate that they relate to the same network-enabled device 340.

When an already deployed device 240 makes a request that requires it to be provisioned with a new identity data unit, the network operator approves the request in accordance with its own internal procedures. In some cases permission to fulfill the request may be granted by the authorization server 230, which may provide a whitelist specifying those devices to be updated to the WGM server 134 associated with the PKI/identity update system 130. Instead of using an authorization server 230 to deliver the whitelist, the network operator may manually deliver the whitelist to the WGM server 134 over an online interface or the like.

Instead of coming from the network operator, in some cases the authorization may come from the factory, particularly when all the devices deployed to a particular network operator are to be upgraded. This authorization may be based, for instance, on a list of all devices shipped to the network operator. The whitelist that is provided includes the identifier used by the network operator, ID-C, for each device that is to be updated. The WGM server 134 obtains the identifiers ID-A, ID-B and ID-C from the various sources and joins them together into a single whitelist for subsequent distribution to the update server 132 and/or to the PKI/identity generation system 120. If the new identity data to be generated is based on/linked to the identifiers ID-A and/or ID-C, it should be protected by the key/certificate previously provisioned in the devices at the factory. In this case the whitelist is delivered from the WGM server 134 to the PKI/identity generation system 120, from which the previous IDs/keys/certificates can be retrieved to protect the new identity data that is generated. If, on the other hand, the new identity data to be generated is based on a new ID (ID-D) that is not associated with a previously generated/provisioned key/certificate, the PKI/identity generation system 120 generates the new identity data before update requests are received and thus does not need this information from the WGM server 134. In this case, the whitelist is directly sent to the update server 132 so that it can be used to check on the device authorization for the update.

Next, the devices 240 to be updated each send a request to the update server 132. The request is signed with an asymmetric private key (or other types of keys such as symmetric keys and identifiers) previously installed at the factory. The asymmetric cryptography-based mechanism provides a strong authentication of the request message, while a simple identity and symmetric key based mechanism provides a weaker authentication. The update server 132 first authenticates the device request message by validating its signature and certificate(s). Any invalid request will be rejected.

Using the appropriate identifiers (such as ID-A, ID-B, or ID-C) for each device 240 requesting an update, the PKI/identity update server 132 can first perform the message authentication check, then perform the authorization check based on the whitelist it receives to ensure that only authorized devices are updated with the new PKI/identity data. The update server 132 also obtains the updated PKI identity data records from the PKI/identity generation system 120. The new PKI identity data records are specified by new identifiers ID-D, which may or may not be based on any of the previous identifiers (ID-A, ID-B, and ID-C). The association of the new and previous PKI/identity data determines how the authorization operation is conducted.

In one case, the new PKI/identity data (IDs and keys) are not related to the previous IDs/keys/certificates. In this case the PKI/identity generation system generates a sufficient pool of new PKI data with internally assigned new identifiers and uploads them to the update server 132 for use. The update server 132 simply checks whether or not a device ID (ID-A, or ID-B, or ID-C) in a request message is included in the whitelist. ID-A may be a separate parameter in the request message or it may be part of the device's digital certificate which was installed at manufacture time. Each request message will be fulfilled with the next available new or unused PKI/identity data record stored in the update server 132. In general, one record will be used for one device, although it is possible that in some cases the same record could be shared among multiple devices. In this process, the update server 132 will pair the device ID with a new PKI/identity data record having the identifier ID-D. This online authorization and device binding process is used to ensure that all devices that are authorized to be upgraded will receive the new PKI/identity data.

On the other hand, if the new PKI/identity data (IDs and keys) are related to the previous IDs/keys/certificates, an offline generation and device binding process may be employed. In this case, the PKI/identity generator system 120 only generates the new IDs/keys/certificates for those devices whose IDs (which could be ID-As, or ID-Bs or ID-Cs) are included on the whitelist. The new identity data is then delivered to the update server 132. The update server 132 only has the new PKI/identity data for devices whose IDs (which could be ID-As, or ID-Bs, or ID-Cs) are on the whitelist; any requests from devices that are not on the whitelist will not be fulfilled. Finally, the new identity data records are delivered by the update server 132 to their respective devices 240 over a public or private network 150 such as the Internet, for example.

The WGM 134 employs a whitelist-based approach to consolidate the various IDs received and to address any conflict in the process of resolving the above issues. In particular, the WGM 134 manages the various identifiers used by different entities and correlates the different whitelist sources from the factories, the PKI management system and the network operator's access authorization servers as well as the update server 132. This is accomplished by cross indexing the identifiers to create a master database for the subsequent generation of specific whitelists that are tailored for a particular network/customer or application. The WGM 134 also manages the associations among the various IDs and their relationships with their respective PKI/Identity data records which are used for different purposes, including online update request authentication, authorization, new identity protection, and so on. If conflicts arise as a result of information received from either of the three identity data sources or as a result of information stored in update server 132 transaction logs, the WGM 134 detects and resolves them.

The following discussion will refer to PKI data instead of more generally to identity data. However, in all cases any of the other aforementioned types of identity data may be used instead of PKI data. Furthermore, the term “PKI Data” does not necessarily imply the type of identity data which includes digital certificates.

As mentioned above, a whitelist generated by the WGM 134 provides control over online authentication of update requests and offline authorization of the PKI generation for a specific device (offline binding of new PKI data with a specific device).

A PKI update request message received by the update server 132 will be authenticated in addition to performing an authorization check. Any request that fails the authentication check, which uses the device key/certificate previously loaded at the factory, will be rejected by the update server 132. A whitelist needs to include an identifier (e.g. ID-A) that is linked to the previous key/certificate installed at factory. The device uses the device key to sign the PKI update request message and the update server 132 uses the device public key/certificate to verify the request message.

The binding between the new PKI data and the device identifiers is performed during the new PKI data generation process based on a whitelist before update requests are received. The PKI generation system is often put offline for a security reason, to avoid an outsider from being able to hack into the PKI generation system and submit key generation requests without proper authorization. The PKI data is generated with advance knowledge of the particular device (and its already configured identifier) to which it will be bound. In addition, the previous key/certificate could be used to encrypt the new PKI identity data to protect online delivery of new PKI identity data.

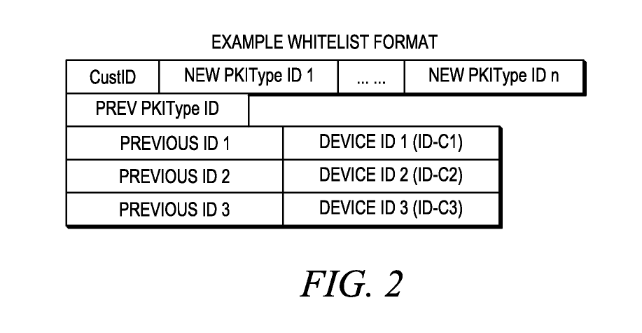

FIG. 2 shows one example of a generic whitelist 400 that may be used for both online request message authentication and offline new identity generation/binding to a specific network-enabled device. The whitelist includes a number of fields that are to be populated by data, including a CustID, New PKI Type ID, Previous PKI Type ID, Previous ID and Device ID. The CustID specifies the identifier of the network operator deploying the list of network-enabled devices from which a request for new PKI data is received. The New PKI Type ID (1, . . . , n) specifies the identifier or identifiers for the type and format of the identity data (also known as PKI Data) that is being requested. If the device is to be provisioned for n sets of identity data, then the whitelist may include n New PKI Type IDs. The Previous PKI Type ID specifies the identity data type that is associated with a device's previous PKI data which has previously been installed into a device, most likely in a factory. The Previous ID specifies the original identifier that was assigned to a deployed device by the secure device provisioning system at the factory. For devices without previously installed PKI data, it is assumed that the device still has some type of a unique identifier (e.g., a chip ID, serial number, MAC Address, etc.) which can be considered to be the Previous ID. In terms of the notation employed above, this identifier is denoted ID-A and is associated with the previous PKI type and data. The Device ID specifies the identifier of the device that is used by the network operator to identify a deployed device. As explained below, depending on particulars of the use case, the Device ID could be any of the previously used IDs (ID-A, ID-B, or ID-C, or unspecified) If an “unspecified” value such as zero is used, the new PKI identity data is not linked to any previously used IDs (ID-A, ID-B, ID-C). A new identifier (ID-D) could be used for new PKI identity generation.

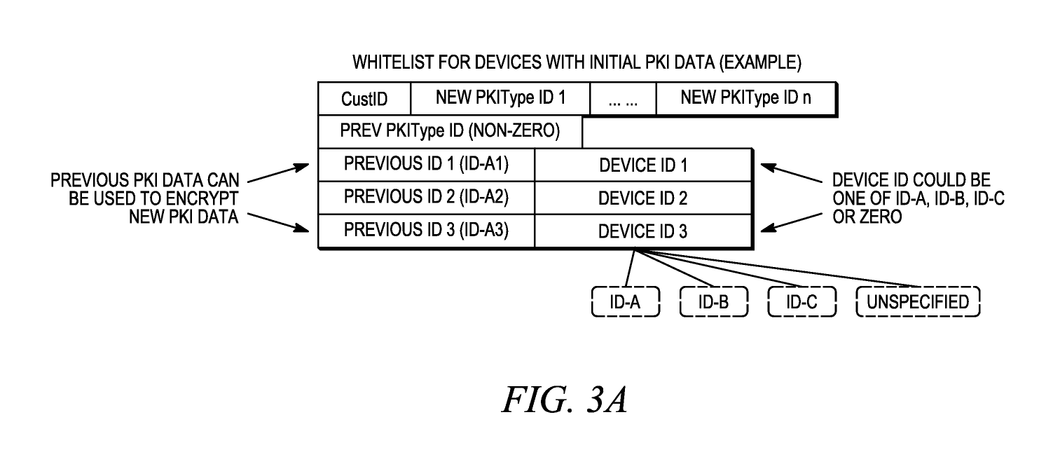

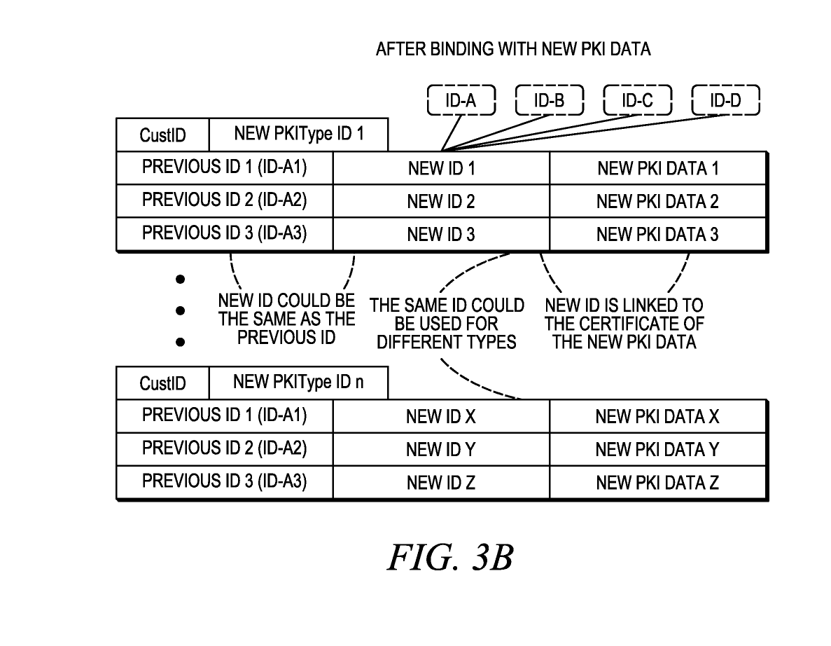

FIG. 3 shows examples of whitelists that may be employed when authorization and device binding are performed during the new PKI identity generation process.

FIG. 3a shows the whitelist for three devices 1, 2 and 3 that have been previously provisioned with PKI data when binding is performed at the PKI/identity generation system 120. The Previous ID may be the identifier ID-A that is linked to the previous PKI identity data. Alternatively, ID-A may be a unique device identifier not liked to any previous PKI identity data for devices that were not previously provisioned with PKI Data. FIG. 3b shows the whitelist after the devices are bound to the new PKI data. As shown, the Device ID, denoted New ID1, New ID2 and New ID3 may be any of the identifiers already assigned to the device, ID-A, ID-B, ID-C or a newly assigned identifier ID-D. Each of the devices 1, 2 and 3 in FIG. 3 are to be provisioned with PKI data records for New PKI Types ID1, ID2, . . . IDN. Additionally, since the New PKI data has been generated for a particular device, the New PKI data for each device is linked to one of the identifiers ID-A, ID-B ID-C or the newly assigned identifier denoted New ID ID-D, which is internally assigned by the PKI generation system 120. The New ID identifier may be linked to the PKI data for a single PKI Type or multiple PKI Types. That is, in FIG. 3b, the New identifiers ID-1, ID-2 and ID-3 (associated with New PKI Type ID1) may or may not be the same as the identifiers ID X, ID Y and ID Z (associated with New PKI Type IDn), respectively.

For devices with initial PKI-based identities installed at the factory, their previous keys and certificates could be used for the protection of the new PKI/identity data. The new key (the private or secret part of the new key pair) is encrypted by the public key of the previous PKI data and can be decrypted only by the device that possesses the private key part of the previous PKI data. If a device was provisioned at the factory with a symmetric key, the new data could be encrypted using the installed symmetric key as well if a copy was maintained by the PKI Generation System 120.

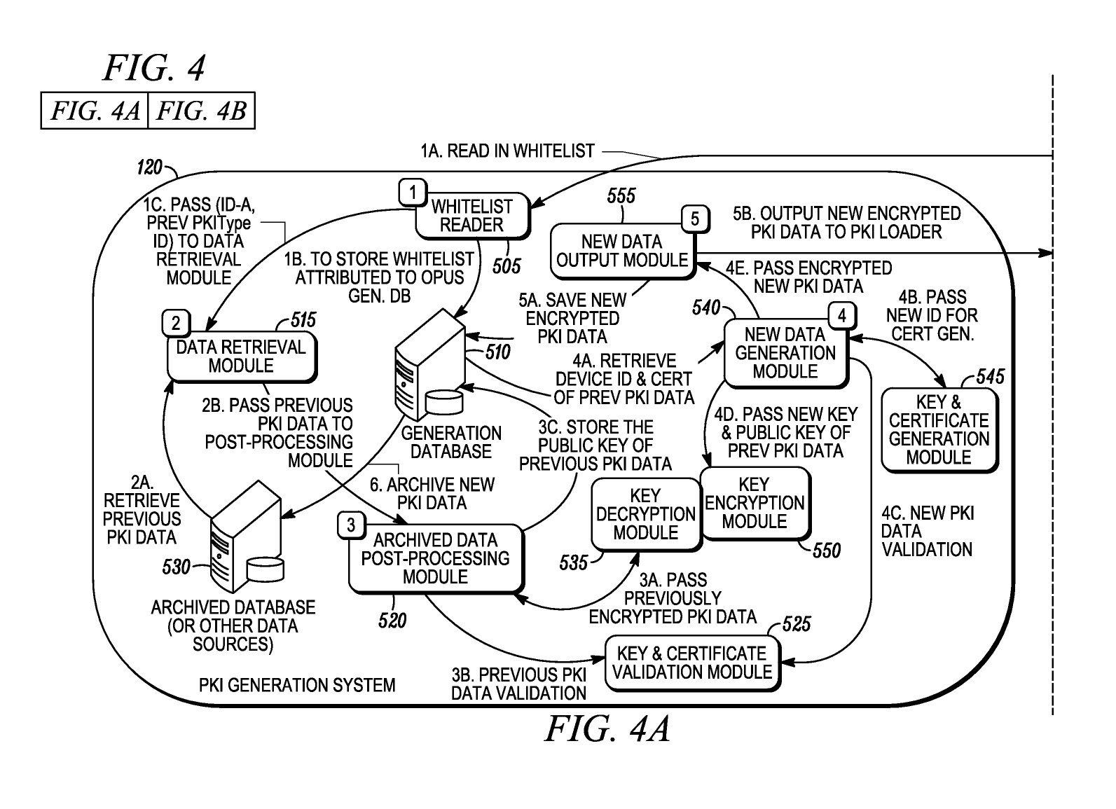

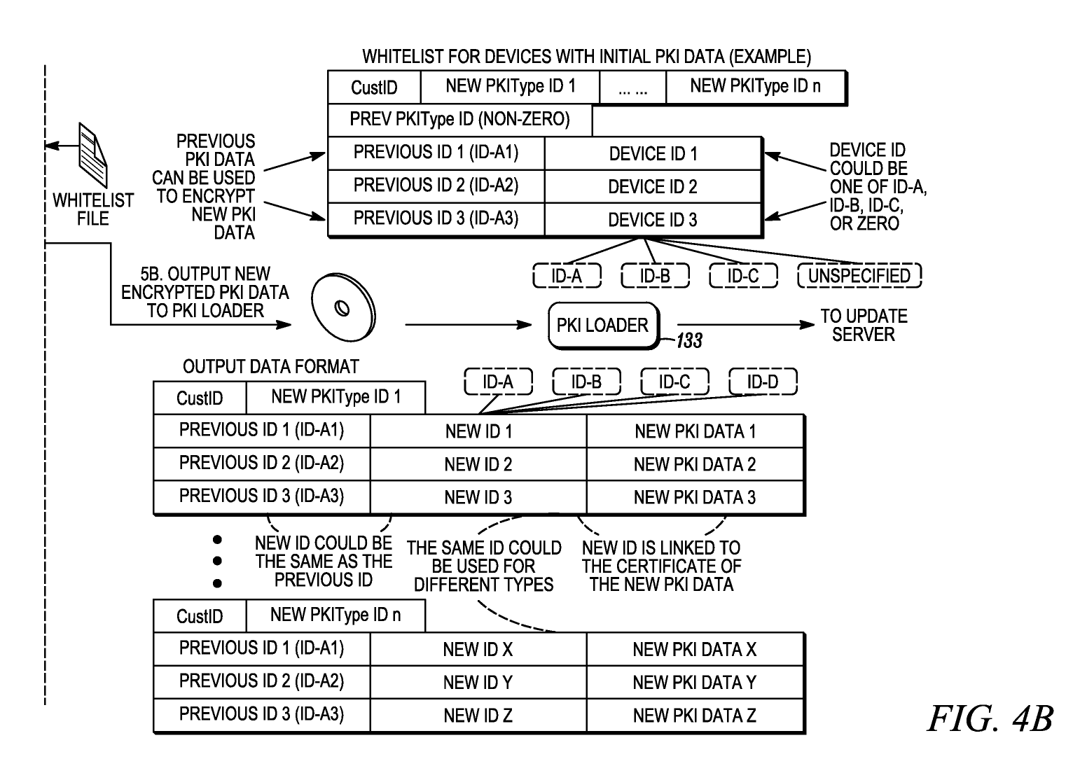

As previously mentioned, the binding between the new PKI data and the device identifiers is performed during the new PKI data generation process based on a whitelist. The PKI generation system is often put offline for security reasons. Thus, the PKI data is generated with advance knowledge of the particular device to which it will be bound. FIGS. 4A and 4B show an example of the PKI/identity generation system 120 when it is used to perform both PKI data generation and device binding.

It should be appreciated that the PKI/identity generation system 120 is only one example of such a system and that it may have more or fewer modules or components than shown, may combine two or more modules or components, or may have a different configuration or arrangement of modules or components. The various modules shown in FIGS. 4A and 4B may be implemented in hardware, software or a combination of both hardware and software, possibly including one or more data processing and/or application specific integrated circuits.

As shown, PKI/identity generation system 120 includes a whitelist reader 505, generation database 510, data retrieval module 515, archived database 530, archived data post processing module 520, decryption module 535, key/certificate validation module 525, new data generation module 540, key encryption module 550 and new data output module 555. With continuing reference to FIGS. 4A and 4B4, the process flow through the various components of the PKI/identity generation system 120 is as follows.

The process starts at 1a, when the whitelist reader 505 reads and parses the whitelist file or files it receives from the WGM 134. The whitelist reader 505 passes the various whitelist attributes to the generation database 510 for storage at 1b. The whitelist reader 505 also passes the previous IDs (ID-As) and PKI type ID (Prey PKIType ID) from the whitelist to the data retrieval module 515 at 1c.

The data retrieval module 515 then performs the following steps. First, at 2a, the data retrieval module 515 retrieves, based on attributes such as the identifiers ID-As and the Prey PKIType ID, the previously generated PKI data (the keys/certificates that are linked to the previous IDs, i.e. ID-As), which have been already archived and stored in the archived database 530 and or other databases. Next, at 2b, the data retrieval module 515 passes the previous PKI data it has retrieved to the archived data post processing module 520. It should be noted that the previous secret portions of the PKI data such as the private key, for example, is generally stored and retrieved in an encrypted form.

The archived data post processing module 520 then performs the following steps. First, at 3a, the module 520 passes the previous PKI data to the decryption module 535 for decryption since the secret portion of the previous PKI data were encrypted before being archived. The PKI data needs to be fully decrypted so that it can undergo a subsequent validation process, and then later can be used for new PKI/identity encryption process. The decrypted PKI data is returned to the archived data post processing module 520, which then passes the data to the key/certificate validation module 525 at 3b. The module 525 then validates each previous private key with its corresponding certificate by encrypting and decrypting a dummy message. This operation performs the anticipated client/device processing to detect any possible corruption or tampering to the previous key/certificate, thereby ensuring that the online update process will be successful. Of course, in other implementations other techniques may be employed to determine if the private key has been corrupted. Moreover, in other implementations, validation is performed only on a subset of the previous private keys and in yet other cases none of the previous private keys are validated. At 3c, the archived data post processing module 520 sends the public key of the previous PKI data to the generation database 510 for storage so that it is available for use in a subsequent process for encrypting new PKI/identity data. The new data generation module 540 then performs the follows steps. First, at 4a the module 540 retrieves the Device ID (which could be ID-A, -B, -C, or “unspecified”) and the public key of the previous PKI data (with ID-A being used) from the generation database 510. It also retrieves the new PKIType ID from the generation database 510. If the Device ID is unspecified in the whitelist, a new ID (ID-D) is assigned by the generation database 510. At 4b, the new data generation module 540 passes a New ID (e.g., ID-A, ID-B, ID-C, or ID-D) to the key/certificate generation module 545, which generates the new PKI data (e.g., key pair and certificate) for each new PKI type specified in the whitelist and returns the new PKI data to the new data generation module 540. In some cases, when the new device identity data includes a digital certificate, the new ID is embedded in the certificate and covered by a digital signature of the Certificate Authority. At 4c, the new data generation module 540 passes the new PKI data to the key/certificate validation module 525, which validates each new private key with its corresponding certificate by encrypting and decrypting a dummy message, which is the operation anticipated to be performed by the network-enabled device after new identity data is received. This process is used to ensure newly generated PKI data are valid. After the data has been successfully validated, the new data generation module 540 at 4d passes the new PKI data and the public key of the previous PKI data to the key encryption module 550 for encryption. Finally, the new data generation module 540 passes the encrypted new PKI data to the new data output module 555.

The new data output module 555 at 5a saves the encrypted new PKI data in the generation database 510 and outputs the encrypted new PKI data at 5b so that the data can be transferred to the PKI loader 133, which in turn loads the data to the update server 132. Finally, the new PKI data (e.g., keys and certificates) are archived by the archive database 530 at 6. The PKI data may be archived upon generation, or alternatively, on some periodic basis (e.g., monthly).

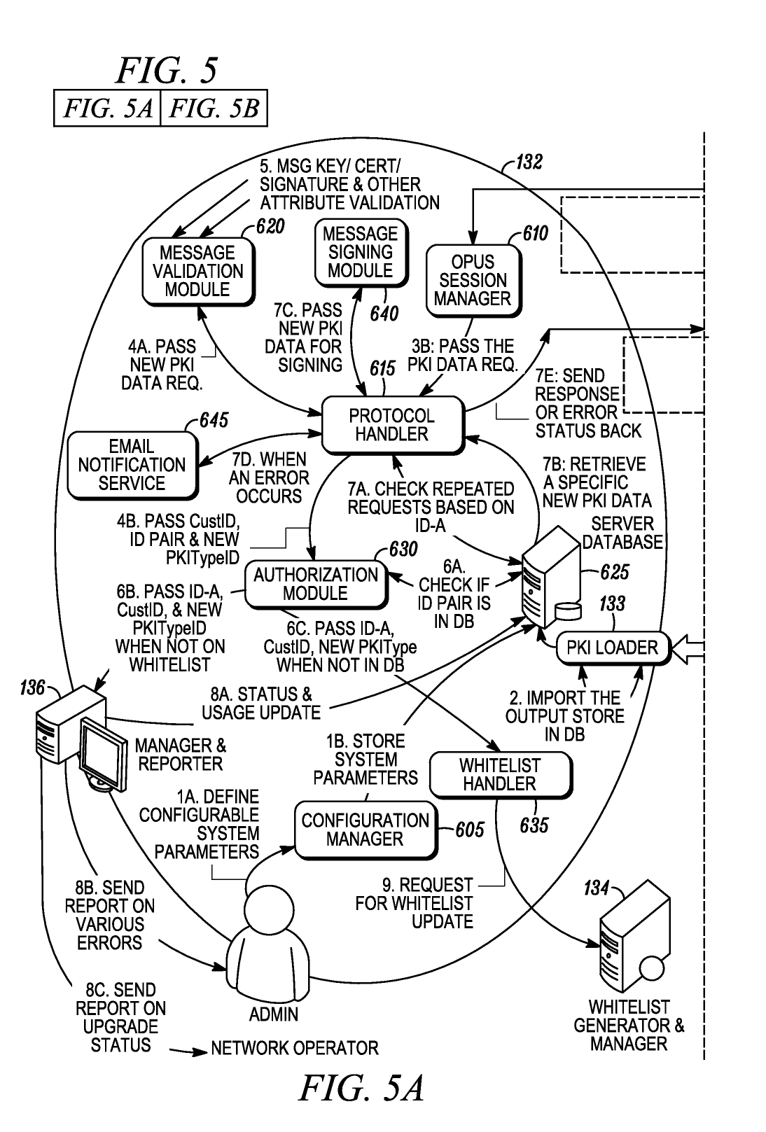

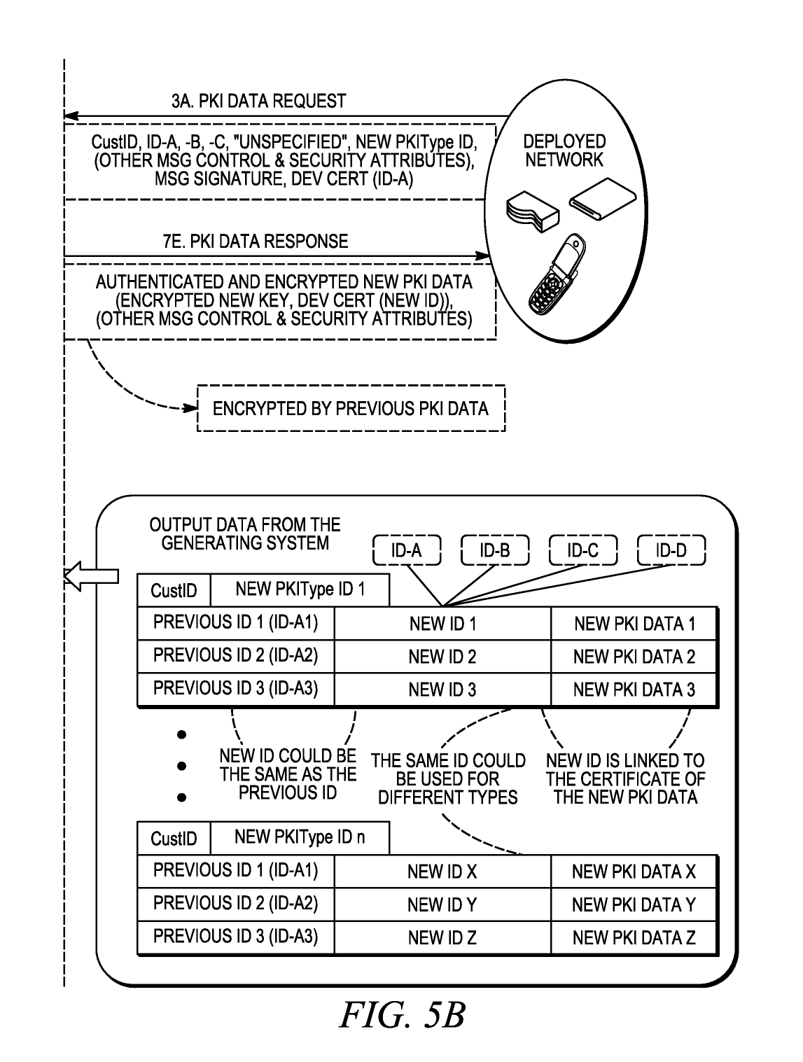

FIGS. 5A and 5B show one example of the update server 132 which receives the output from the PKI/identity generation system 120 of FIGS. 4A and 4B and PKI data requests from the network-enabled devices. As previously mentioned, after receiving and validating the request, the update server 132 returns the uniquely protected and authenticated PKI data back to the device.

In some cases, the PKI Data may in general be encrypted twice—once using the previous PKI Data provisioned into the device and optionally the second time using a key agreement algorithm such as a Diffie-Hellman or Elliptic Curve Diffie-Hellman. Key agreement may be used to generate a unique per-transaction encryption key and is useful in the cases when the original PKI Data in the device has a key size which is too short. For example, the new PKI Data may include a 2048-bit RSA key while the original PKI Data may include a 1024-bit RSA key. It is technically possible to take 1024-bit RSA key and encrypt with it a temporary symmetric key which is in turn used to encrypt the larger 2048-bit RSA key. This process is generally referred to as “wrapping” but it is not considered to be sufficiently secure and so key agreement with a larger key size (e.g., 2048-bit Diffie-Hellman) may be added in this case.

In order to enable the additional encryption based on key agreement, the PKI Data request in step 3a contains the device's randomly generated Key Agreement Public Key (KAPK-Device). The server generates its own Key Agreement Key Pair (KAKP-Server), utilizes its private key KAPrK-Server and KAPK-Device to generate a symmetric session key and then adds a second layer of encryption to the new PKI Data. This step may be performed after step 7d, discussed below. In the response message (sent in step 7e discussed below) the server includes its Key Agreement Public Key (KAPK-Server).

The device then validates, decrypts and installs the new PKI data. In order to remove the optional outer layer encryption, the device utilizes KAPK-Server and its own previously generated private key KAPrK-Device to generate the same session key as the server and then utilizes the session key for decryption.

Similar to the PKI/identity generation system 120 of FIGS. 4A and 4B, the update server 132 in FIGS. 5A and 5B is only one example of such a system and it may have more or fewer modules or components than shown, may combine two or more modules or components, or it may have a different configuration or arrangement of modules or components.

As shown, update server 132 includes a configuration manager 605, server database 625, session manager 610, protocol handler 615, message validation module 620, authorization module 630 and whitelist handler 635. Also shown in FIGS. 5A and 5B is the manager and reporter 136 and PKI loader 133 and WGM 134. With continuing reference to FIG. 6, the process flow through the various components of the update server 132 is as follows.

The process starts at 1a when a system administrator provides the configuration manager 605 with various system configuration parameters. For instance, one parameter may specify the maximum number of repeat requests allowed from the same device for a specific PKI type and network operator. That is, the number of repeat requests may be different for different network operators and even different types of PKI data for the same network operator. Another parameter may specify the amount of time that must elapse before receiving successive requests from the same device. Yet other parameters may relate to various security checks and the like that are to be performed. The use of these system parameters can allow both efficient preprocessing to maintain server performance while allowing a sufficient number of device retries to account for request failures and/or disruptions. At 1b the system configuration parameters are stored in the server database 625.

The PKI loader 133 imports to the server database 625 at 2 the new identity records that were output from the offline PKI generation system 120. The data that is stored includes the CustID, New PKI TypeID, the new PKI data and the ID pairing information between the identifier (ID-A) of the previous PKI data and the New ID of the new PKI data.

At 3a, the session manager 610 receives a PKI data request from a specific device. The request includes data such as the CustID, the device identifier (ID-A or ID-B or ID-C), the device certificate and a signature. The request is passed to the protocol handler 615 at 3b. The protocol handler 615, in turn, passes the new PKI data request to the message validation module 620 at 4a. In addition, the protocol handler 615 also passes at 4b the aforementioned ID pairing information, the new PKI Type ID and CustID to the authorization module 630.

At 5, the message validation module 620 checks the format of the PKI data request, verifies the signature, validates the key and certificate chain, and checks that the message conforms to various message protocols to determine, for example, that the message has a proper timestamp and/or sequence number.

The authorization module 630 determines at 6a if the requesting device is authorized for an upgrade for the particular new PKI type that is being requested. Such verification of the device's authorization to receive an upgrade can be accomplished by confirming that the paired IDs (the previous ID (ID-A) linked to the previous identity data and the New ID for the device, which corresponds to ID-A, ID-B, ID-C) in the upgrade request are also in the server database 625, which obtained this information at 2 from the data received from the PKI/identity generation system 120. If the authorization verification fails, the authorization module 630 at 6b passes any missing ID pairing information between the previous ID (ID-A) and the New ID (ID-A, or -B, or -C, or -D), along with the CustID, to the monitor and reporter 136 so that the network operator may be notified. This notification indicates that although the request for new PKI data which was received from the device is valid, the necessary information needed to perform the upgrade was not made available to the update server 132 by the PKI/identity generation system 120. In addition, the missing ID pairing information, along with the CustID, is passed to the whitelist handler 635 at 6c, which as discussed below, can request the WGM 134 to perform whatever steps are necessary to provide the update server 130 with the missing information.

The protocol handler 615 next checks with the server database 625 at 7a to see if the number of repeated requests from the same device is less than the maximum allowed amount. The purpose of this check is to ensure that the update server 132 can stop responding to a rogue device that repeatedly sends new PKI data requests to the server. If the maximum number of requests has not been exceeded, at 7b a new PKI data record is retrieved from the database 625 based on the combination of the previous ID, new ID and the new PKI Type ID. The new PKI data record in incorporated into a new PKI data response message, which at 7c is sent to the message signing module 640 so that it can be signed with the private key of the update server 132. If an error occurs in this process, at 7d the protocol handler 615 sends a status error message to the email notification module 645. In some cases the protocol handler may also send an error message to the device since the device may have some error handling capabilities. Assuming no error has occurred, the signed new PKI data response message is sent to the device at 7e.

The monitor and reporter 136 retrieves at 8a various usage data and status information from the server database 625 as well as transaction and error logs. Examples of the usage data are the number of new PKI data records loaded and requested, the identification of records that are requested more than once or requested for the maximum allowed number of times, and so on. The monitor and reporter 136 sends this information at 8b to the system administrator, indicating any errors that have occurred. At 8c, the monitor and reporter 136 also sends periodic reports to the network operator so that they are informed of the upgrade status. Finally, the whitelist handler 635 sends a message back to the WGM 134 requesting any ID pairing information that is missing so the WGM 134 can send the missing paired identifiers to the PKI/identity generation system for new PKI/identity generation.

As used in this application, the terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

1. A system for generating new identity data for network-enabled devices, comprising:
a whitelist reader configured to extract attributes from a whitelist that includes, for each device specified in the whitelist, a previously assigned identifier of the first type, wherein the previously assigned identifiers of the first type are linked to identity data previously provisioned in each of the respective devices;
a data retrieval module configured to receive the identifiers of the first type from the whitelist reader and, based on each of the identifiers, retrieve each of the previously provisioned identity data records linked thereto;
a new data generation module configured to (i) obtain a cryptographic key associated with the identity data previously provisioned in the devices specified on the whitelist and the corresponding identifiers of the first type and (ii) generate new identity data records each linked to a new identifier and (iii) encrypt each of the new identity data records with one of the cryptographic keys and link each new identity data record to the identifier of the first type corresponding to each respective cryptographic key; and
a data output module configured to load onto an external source the encrypted new identity data records along with their respective new identifiers and their respective previously assigned identifiers of the first type.

2. The system of claim 1 wherein the previously provisioned identity data records are encrypted and further comprising a key decryption module for decrypting the previously provisioned identity data records prior to receipt of the cryptographic key by the new data generation module.

3. The system of claim 1 further comprising a validation module for validating at least a subset of the decrypted previously provisioned identity data records to ensure their accuracy.

4. The system of claim 1 further comprising a first database configured to store (i) the attributes extracted by the whitelist reader from the whitelist and (ii) the cryptographic key and wherein the new data generation module is further configured to receive the cryptographic key from the first database.

5. The system of claim 4 wherein the first database is further configured to store the encrypted new identity data records.

6. The system of claim 1 wherein the new identifiers are identifiers previously provisioned in the devices at a manufacturing facility.

7. The system of claim 1 wherein the new identity data records include a digital certificate and the new data generation module is further configured to embed the new identifier in the digital certificate of the respective new identity data record.

8. The system of claim 1 wherein the new data generation module is further configured to obtain an asymmetric key that serves as the cryptographic key and retrieve the asymmetric key from a digital certificate associated with the identity data record previously provisioned in the devices specified on the whitelist.

9. A method for generating new identity data for network-enabled devices, comprising:
receiving a whitelist that specifies a plurality of network-enabled devices to be provisioned with new identity data wherein, for each device, the whitelist includes a previously assigned identifier of the first type, wherein the previously assigned identifiers of the first type are linked to identity data records previously provisioned in each of the respective devices;
extracting the identifiers of the first type from the whitelist and, based on each of the identifiers, retrieving each of the previously provisioned identity data records linked thereto;
obtaining a cryptographic key associated with the identity data records previously provisioned in the devices specified on the whitelist and the corresponding identifiers of the first type;
generating new identity data records each linked to a new identifier;
encrypting each of the new identity records with one of the cryptographic keys and linking each new identity record to the previously assigned identifier of the first type corresponding to each respective cryptographic key; and
providing an output that includes, for each of the devices specified on the whitelist, the encrypted new identity records along with their respective new identifiers and their respective previously assigned identifiers of the first type.

10. The method of claim 9 wherein the cryptographic key is an asymmetric key and obtaining the cryptographic key includes retrieving the asymmetric key from a digital certificate associated with the identity data record previously provisioned in the devices specified on the whitelist.

11. The method of claim 9 wherein the whitelist that is received includes authorization to provision the plurality of network-enabled devices with the new identity data.

12. A method for updating network-enabled devices with new identity data, comprising:
receiving a request for new identity data from a plurality of network-enabled devices, said request including a previous identifier linked to previous identity data previously provisioned in the network-enabled devices;
receiving a plurality of new identity records that each include new identity data and new identifiers respectively linked to the new identity data, and a previous identifier linked to previous identity data previously provisioned in network-enabled devices authorized to receive new identity data;
determining that each of the plurality of network-enabled devices specified in the request for new identity data are authorized to receive new identity data;
retrieving a first of the new identity records that includes a first previous identifier of a first of the network-enabled devices; and
sending the new identity data included in the first new identity record to the network-enabled device identified by the first previous identifier.

13. The method of claim 12 wherein at least a portion of the new identity data send to a particular device is encrypted with a cryptographic key associated with the previous identity data of the particular device.

14. The method of claim 12 further comprising validating the request by at least verifying a signature of the request.

15. The method of claim 12 wherein determining that each of the plurality of network-enabled devices specified in the request for new identity data are authorized to receive the new identity data includes confirming that the previous identifier included in the request is also included in the new identity records that have been received.

16. The method of claim 12 wherein, if determining that each of the plurality of network-enabled devices specified in the request for new identity data are authorized to receive the new identity data fails, sending a message requesting any information missing from the new identity records.

17. The method of claim 12 further comprising determining that a number of requests for new identity data is not received from a given network-enabled devices more than a maximum allowed number of times.

18. A server, comprising:
a session manager configured to receive requests for new identity data from network-enabled devices, each of said requests including a previously assigned identifier identifying the respective network-enabled device sending the request, the previously assigned identifier being linked to identity data records previously provisioned in the respective network-enabled device;
an authorization module configured to determine if the network-enabled devices specified on the whitelist are authorized to be provisioned with new identity data;
a database configured to receive new identity records generated by an identity data generation system, wherein the new identity records include pairing information associating one of the previously assigned identifiers with a new identifier of one of the new identity records; and
a protocol handler configured to deliver a data response message to each of the network-enabled devices requesting new identity data, each of the data response messages including a new identity record that is selected based at least in part on the previously assigned identifier of the network-enabled device to which the data response message is sent.

19. The server of claim 18, further comprising a configuration manager for receiving user input specifying a maximum number of repeat requests that are allowed from a particular network-enabled device.

20. The server of claim 18, wherein the authorization module is configured to determine if the network-enabled devices specified on the whitelist are authorized to be provisioned with new identity data by determining if pairing information included in the request is also in the database.
